(19) United States
(12) Patent Application Publication
(10) Pub. No.: US 2025/0309340 A1
(43) Pub. Date: Oct. 2, 2025

(54) ALL-SOLID-STATE BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Masahiro HOKAZONO, Saitama (JP); Fumikazu NAKAZAWA, Saitama (JP)

(21) Appl. No.: 19/034,562

(22) Filed: Jan. 23, 2025

(30) Foreign Application Priority Data
Mar. 26, 2024 (JP) 2024-049131

(51) Int. Cl. H01M 10/0562; H01M 10/0585

(52) U.S. Cl. CPC H01M 10/0562; H01M 10/0585

(57) ABSTRACT

The present disclosure provides an all-solid-state battery capable of suppressing damage to the end of the positive electrode under compressive stress due to compressive input, while ensuring sufficient insulation between the positive electrode and the negative electrode, mitigating stress concentration at the end of the electrode stack in the stacking direction due to the expansion and contraction of the negative electrode during charge and discharge cycles of the all-solid-state battery, suppressing abnormal lithium metal deposition caused by localized battery reactions, and preventing capacity degradation of the all-solid-state battery. An all-solid-state battery according to an embodiment for solving the above objectives includes: an electrode stack including a plurality of electrode bodies stacked, in which a resin coating capable of following the expansion and contraction of the electrode stack is provided at the end of the electrode stack in the stacking direction.

This application is based on and claims the benefit of priority from Japanese Patent Application No. 2024-049131, filed on 26 Mar. 2024, the content of which is incorporated herein by reference.

### BACKGROUND OF THE INVENTION

### Field of the Invention

The present invention relates to an all-solid-state battery.

### Related Art

In recent years, research and development on secondary batteries contributing to energy efficiency have been conducted to ensure more people have access to affordable, reliable, sustainable, and advanced energy solutions. Among secondary batteries, lithium metal batteries with high energy density have attracted significant attention.

Lithium metal batteries are secondary batteries that use lithium metal as the negative electrode, potentially enabling high-capacity batteries. In particular, so-called all-solid-state lithium metal batteries, which replace the liquid electrolyte with a solid electrolyte layer, have drawn attention due to their superior safety. The cell structure of all-solid-state lithium metal batteries include, for example, a negative electrode made of lithium metal, a positive electrode, and a solid electrolyte layer.

FIG. 5 is a cross-sectional view illustrating the structure of an all-solid-state battery of prior art. As illustrated in FIG. 5, the electrode stack 1 of the all-solid-state battery includes: a negative electrode formed of a negative electrode current collector 2a and a lithium metal layer (negative electrode layer) 3a, or formed of a negative electrode current collector 2b and a lithium metal layer (negative electrode layer) 3b; a positive electrode formed of a positive electrode current collector 4 and a positive electrode active material layer (positive electrode layer) 5a or 5b; and solid electrolyte layers 6a and 6b adjacent to the positive electrode active material layers (positive electrode layers) 5a and 5b, respectively.

The electrode stack 1 of the all-solid-state battery illustrated in FIG. 5 includes: an intermediate layer 7a between the lithium metal layer (negative electrode layer) 3a and the solid electrolyte layer 6a; and an intermediate layer 7b between the lithium metal layer (negative electrode layer) 3b and the solid electrolyte layer 6b.

Insulating materials 8a are arranged at both ends of the positive electrode active material layer (positive electrode layer) 5a, and insulating materials 8b are arranged at both ends of the positive electrode active material layer (positive electrode layer) 5b. As the materials for the insulating materials 8a and 8b, materials without electronic conductivity are used; however, materials with ionic conductivity are usable, and solid electrolytes are also usable. In the drawings, Ld denotes the stacking direction of the electrode stack 1 constituting the all-solid-state battery, and Vd denotes a direction (plane direction) perpendicular to the stacking direction of the electrode stack 1 constituting the all-solid-state battery.

The module assembly process of an all-solid-state battery includes a step of applying compressive input, in which a compressive stress of approximately 1 MPa is applied. As illustrated in FIG. 6, the compressive input applies pressure to the electrode stack 1 from the outside in the direction Vd perpendicular to the stacking direction Ld of the electrode stack 1.

In this case, as illustrated in FIG. 5, the electrode stack 1 has a structure, in which the positive electrode active material layers (positive electrode layers) 5a and 5b including the insulating material 8a and 8b at the ends, respectively, extend outward beyond the ends of the electrode stack 1 in the direction Vd (plane direction) perpendicular to the stacking direction Ld of the electrode stack 1. As a result, when compressive stress is applied, damage such as bending or breaking may occur.

Accordingly, in order to suppress damage to the ends of the positive electrode under compressive stress due to compressive input, while ensuring sufficient insulation between the positive electrode and the negative electrode, it has been proposed to provide a resin coating (see the number 9 in FIG. 6) at the ends of the electrode stack in the stacking direction.
Patent Document 1: Japanese Unexamined Patent Application, Publication No. 2023-39756

### SUMMARY OF THE INVENTION

However, when a resin coating is provided at the ends of the electrode stack in the stacking direction, stress is concentrated particularly on the positive electrodes and the solid electrolyte layers at both ends of the electrode stack in the stacking direction, due to the expansion and contraction of the negative electrode during charge and discharge cycles of an all-solid-state battery. FIGS. 7A and 7B illustrate the stress concentration during charging and discharging, in an all-solid-state battery including the resin coating 9 at the ends of the electrode stack 1 in the stacking direction Ld. FIG. 7A illustrates the state of the all-solid-state battery during full discharge (SOC: 0%), and FIG. 7B illustrates the state of the all-solid-state battery during full charge (SOC: 100%).

As illustrated in FIG. 7A, in the all-solid-state battery during full discharge (SOC: 0%), the lithium metal layers (negative electrode layers) 3a and 3b are not expanded, and the resin coating 9 provided in the stacking direction Ld of the electrode stack 1 extends to the same thickness as the electrode stack 1, at the end of the electrode stack 1.

In the all-solid-state battery, as the state of charge increases, the negative electrode increasingly expands. As illustrated in FIG. 7B, in the all-solid-state battery during full charge (SOC: 100%), the thickness of the electrode stack 1 (dimension in the stacking direction Ld) increases due to the expansion of components such as the lithium metal layers (negative electrode layers) 3a and 3b, surpassing the thickness of the electrode stack 1 (length in the stacking direction Ld) during full discharge (SOC: 0%). Consequently, the thickness of the electrode stack 1 (length in the stacking direction Ld) exceeds the length of the resin coating 9 in the stacking direction Ld of the electrode stack 1, and the resin coating 9 pulls the positive electrodes and the solid electrolyte layers at both ends of the electrode stack 1 in the stacking direction Ld, causing stress concentration in these areas.

Repeated charge and discharge cycles in the all-solid-state battery lead to repeated stress concentration on the positive electrodes and the solid electrolyte layers at both ends of the electrode stack in the stacking direction. As a result, cracks or other damage may occur in the solid electrolyte layers at the ends of the electrode stack, leading to abnormal lithium metal deposition due to localized battery reactions. Similarly, damage such as cracks may occur in the positive electrode active material layers (positive electrode layers) at the ends of the electrode stack, resulting in a reduction in the capacity of the all-solid-state battery.

The present invention has been made in view of the above, and an object of the present invention is to provide an all-solid-state battery capable of suppressing damage to the end of the positive electrode under compressive stress due to compressive input, while ensuring sufficient insulation between the positive electrode and the negative electrode, mitigating stress concentration at the end of the electrode stack in the stacking direction due to the expansion and contraction of the negative electrode during charge and discharge cycles of the all-solid-state battery, suppressing abnormal lithium metal deposition caused by localized battery reactions, and preventing capacity degradation of the all-solid-state battery.

The inventors of the present invention have diligently studied to achieve the above object. The inventors of the present invention have discovered that the above problems can be resolved by providing a resin coating capable of following the expansion and contraction of the electrode stack at the end of the electrode stack in the stacking direction, thereby leading to the completion of the present invention.

The all-solid-state battery of the present disclosure includes the following aspects:
(1) An all-solid-state battery including: an electrode stack including a plurality of electrode bodies stacked, each of the electrode bodies including a positive electrode current collector, a positive electrode layer, a solid electrolyte layer, a negative electrode layer, and a negative electrode current collector stacked in this order. The positive electrode current collector includes an insulating material on a surface on the positive electrode layer side, adjacent to the end of the positive electrode layer. The solid electrolyte layer is arranged in contact with the positive electrode layer and the insulating material. In a direction perpendicular to a stacking direction of the electrode stack, the end of the insulating material is arranged outward beyond the end of the negative electrode layer and the negative electrode current collector. In the stacking direction of the electrode stack, a resin coating is arranged at the end of the electrode stack, in contact with the end of the insulating material. The resin coating includes a hard layer and a soft layer in the direction perpendicular to the stacking direction of the electrode stack. The hard layer is arranged at both ends of the electrode stack in the stacking direction.
(2) The all-solid-state battery as described in (1), in which the hard layer is longer than the soft layer, at the end of the resin coating not in contact with the insulating material, in the stacking direction of the electrode stack.
(3) The all-solid-state battery as described in (1) or (2), in which the soft layer includes two or more layers.
(4) The all-solid-state battery as described in (1) or (2), in which the end of the soft layer extends outward beyond the end of the hard layer, in the direction perpendicular to the stacking direction of the electrode stack.
(5) The all-solid-state battery as described in (1) or (2), in which the thickness of the soft layer decreases from the end in contact with the insulating material toward the end not in contact with the insulating material, in the direction perpendicular to the stacking direction of the electrode stack.

The all-solid-state battery of the aspect (1) is capable of suppressing damage to the end of the positive electrode under compressive stress due to compressive input, while ensuring sufficient insulation between the positive electrode and the negative electrode, mitigating stress concentration at the end of the electrode stack in the stacking direction due to the expansion and contraction of the negative electrode during charge and discharge cycles, suppressing abnormal lithium metal deposition caused by localized battery reactions, and preventing capacity degradation of the all-solid-state battery.

The all-solid-state battery of the aspect (2) includes the relatively long hard layer, which can effectively distribute stress at the ends of the electrode stack in the stacking direction, thereby allowing for suppressing stress concentration.

The all-solid-state battery of the aspect (3) includes two or more soft layers, which deform to follow the expansion and contraction of the negative electrode during charge and discharge cycles, thereby allowing for suppressing stress concentration at the ends of the electrode stack in the stacking direction.

In the all-solid-state battery of the aspect (4), the end of the soft layer is arranged outward beyond the end of the hard layer in the direction perpendicular to the stacking direction of the electrode stack. Therefore, the proportion of the hard layer in the stacking direction can be ensured, while increasing the range allowing the soft layer to deform to follow the expansion and contraction of the negative electrode during charge and discharge cycles.

In the all-solid-state battery of the aspect (5), the thickness of the soft layer decreases from the end in contact with the insulating material to the end not in contact with the insulating material in the direction perpendicular to the stacking direction of the electrode stack, relatively increasing the proportion of the hard layer in the stacking direction at the end not in contact with the insulating material. Consequently, the hard layer distributes the compressive input in the region at the end not in contact with the insulating material, while allowing the widely present soft layer to follow the expansion and contraction of the negative electrode during charge and discharge cycles.

### BRIEF DESCRIPTION OF THE DRAWINGS

FIG. 1A is a cross-sectional view illustrating the configuration of an all-solid-state battery of the first embodiment (during full discharge);

FIG. 1B is a cross-sectional view illustrating the configuration of the all-solid-state battery of the first embodiment (during full charge);

FIG. 2A is a cross-sectional view illustrating the configuration of an all-solid-state battery of the second embodiment;

FIG. 2B is a cross-sectional view illustrating the configuration of a first modification of the all-solid-state battery illustrated in FIG. 2A;

FIG. 2C is a cross-sectional view illustrating the configuration of a second modification of the all-solid-state battery illustrated in FIG. 2A;

FIG. 3 is a cross-sectional view illustrating the configuration of an all-solid-state battery of a third embodiment;

FIG. 4 is a cross-sectional view illustrating the configuration of an all-solid-state battery of a fourth embodiment;

FIG. 5 is a cross-sectional view illustrating the configuration of an electrode stack of the conventional art;

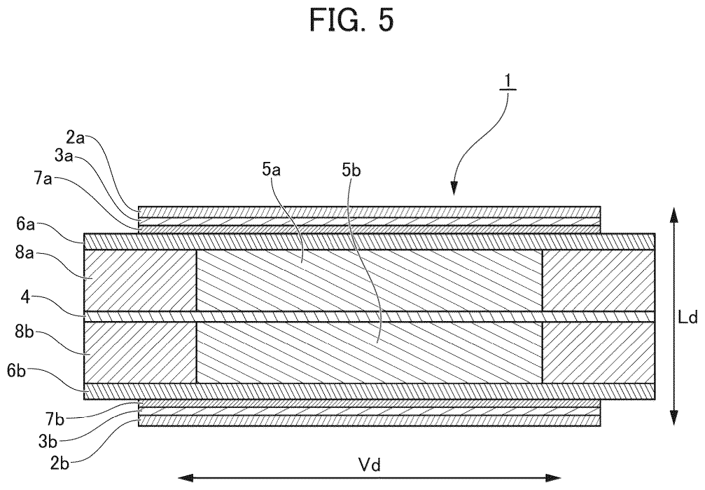

FIG. 6 is a cross-sectional view illustrating the configuration of an all-solid-state battery of the conventional art;

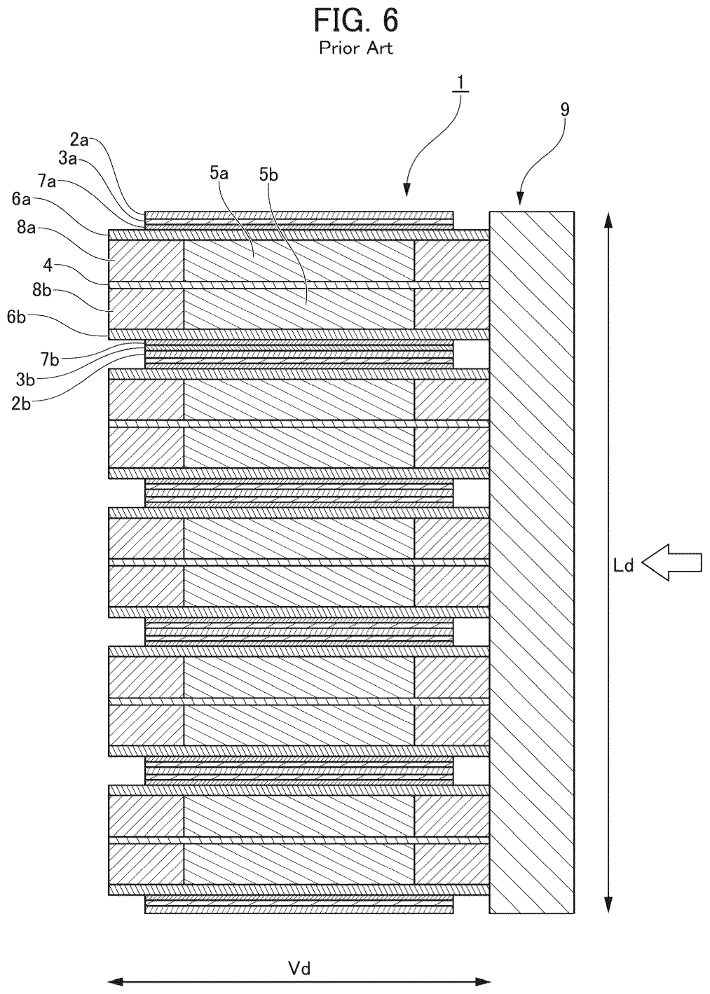

FIG. 7A is a diagram for illustrating the stress concentration during charge and discharge cycles in the all-solid-state battery of the conventional art (during full discharge); and

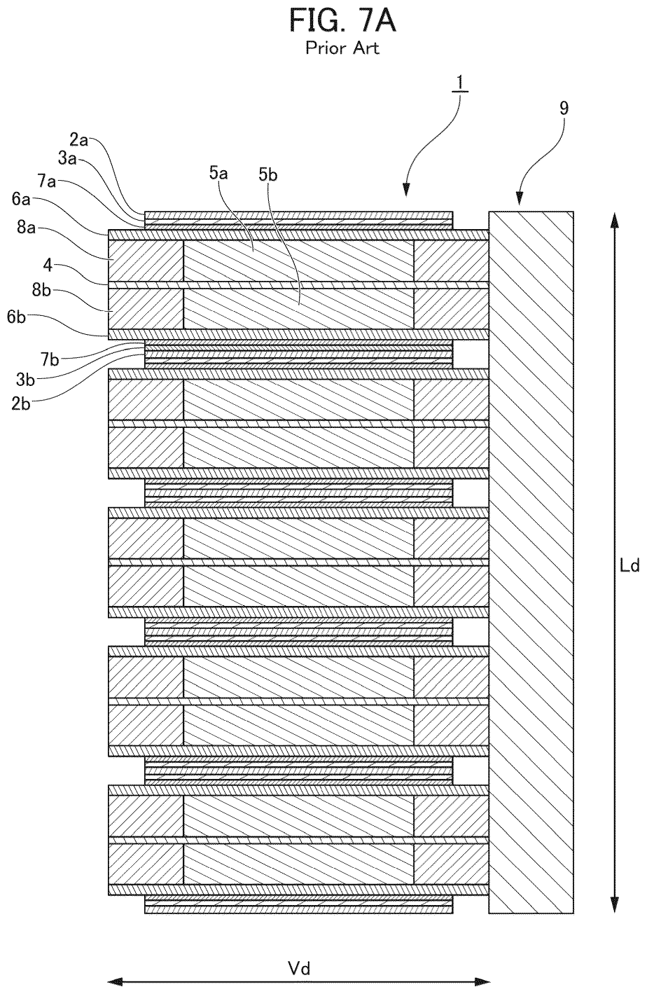

FIG. 7B is a diagram for illustrating the stress concentration during charge and discharge cycles in the all-solid-state battery of the conventional art (during full charge).

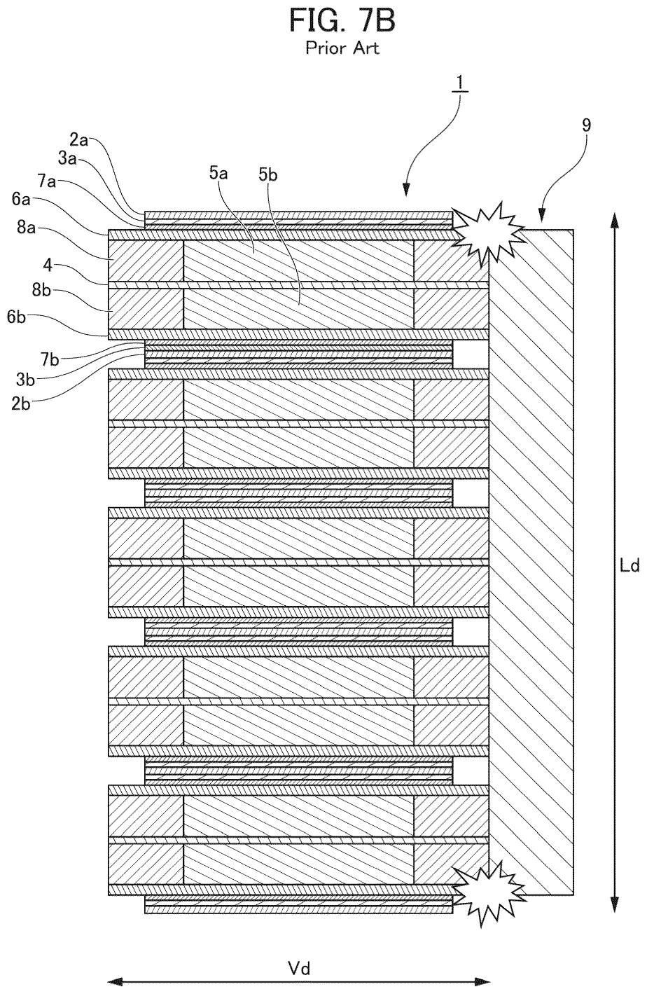

### DETAILED DESCRIPTION OF THE INVENTION

### (All-Solid-State Battery)

The all-solid-state battery of the present disclosure includes an electrode stack including a plurality of electrode bodies stacked, each of the electrode bodies including a positive electrode current collector, a positive electrode layer, a solid electrolyte layer, a negative electrode layer, and a negative electrode current collector stacked in this order. The positive electrode current collector includes an insulating material on the surface on the positive electrode layer side, adjacent to the end of the positive electrode layer. The solid electrolyte layer is arranged in contact with the positive electrode layer and the insulating material.

In the all-solid-state battery of the present disclosure, the end of the insulating material is arranged outward beyond the end of the negative electrode layer and the end of the negative electrode current collector, in a direction perpendicular to the stacking direction of the electrode stack. Furthermore, a resin coating is arranged at the end of the electrode stack in contact with the end of the insulating material, in the direction perpendicular to the stacking direction of the electrode stack.

In the all-solid-state battery of the present disclosure, the resin coating includes a hard layer and a soft layer in the direction perpendicular to the stacking direction of the electrode stack. The hard layer is arranged at both ends of the electrode stack in the stacking direction.

The resin coating includes two layers with differing hardness: a hard layer and a soft layer, whereby the hard layer functions to alleviate compressive stress caused by compressive input. As a result, the all-solid-state battery of the present invention ensures sufficient insulation between the positive electrode and the negative electrode while suppressing damage to the end of the positive electrode.

The resin coating may include C-chamfered or R-chamfered corners at the end not in contact with the insulating material in the stacking direction of the electrode stack. The C-chamfered or R-chamfered corners can prevent stress concentration at the corners, improving robustness against stacking misalignment during assembly or compressive input.

The hard layer is preferably longer than the soft layer at the end of the resin coating not in contact with the insulating material in the stacking direction of the electrode stack. The hard layer longer than the soft layer can sufficiently alleviate the stress during compressive input, and also suppress deformation caused by bending during cell constraint or charging.

In the all-solid-state battery of the present disclosure, the resin coating is arranged at the end of the electrode stack in contact with the end of the insulating material in the direction perpendicular to the stacking direction of the electrode stack. The resin coating includes the hard layer and the soft layer in the stacking direction of the electrode stack. The hard layer is arranged at both ends of the electrode stack in the stacking direction. This configuration can suppress damage to the ends of the positive electrode under compressive stress caused by compressive input, while ensuring sufficient insulation between the positive electrode and the negative electrode, mitigate stress concentration at the ends of the electrode stack in the stacking direction caused by the expansion and contraction of the negative electrode during charge and discharge cycles, prevent abnormal lithium metal deposition due to localized battery reactions, and suppress capacity degradation of the all-solid-state battery.

### First Embodiment

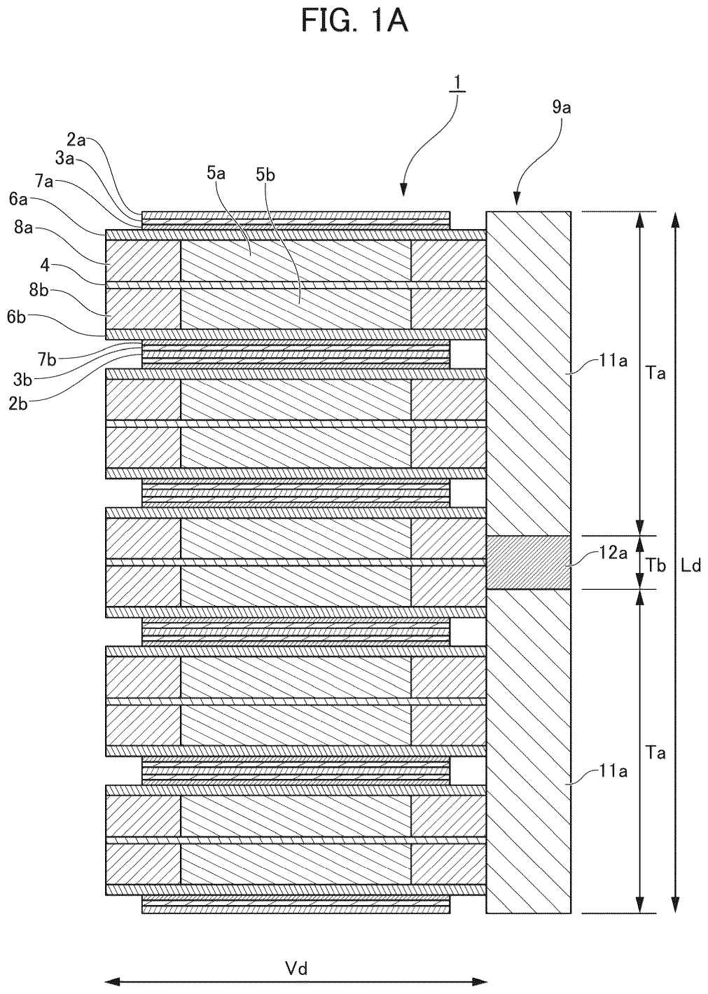

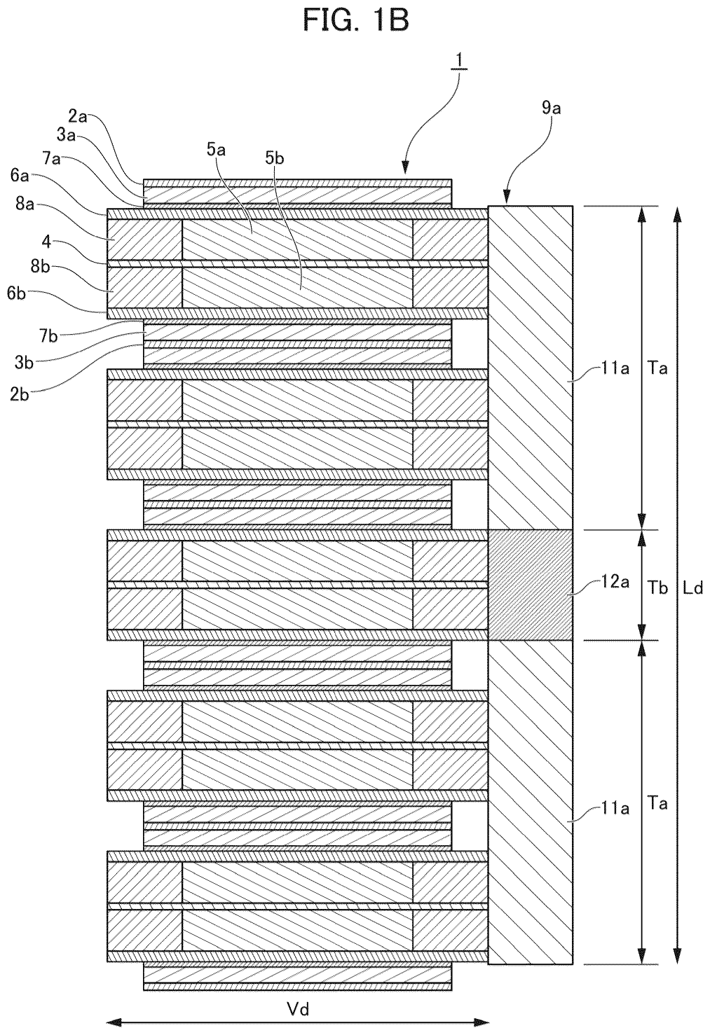

FIGS. 1A and 1B are cross-sectional views illustrating the configuration of an all-solid-state battery according to the first embodiment. FIG. 1A illustrates the state of the all-solid-state battery according to the first embodiment during full discharge (SOC: 0%), and FIG. 1B illustrates the state of the all-solid-state battery according to the first embodiment during full charge (SOC: 100%).

The electrode stack 1 of the all-solid-state battery illustrated in FIGS. 1A and 1B includes: a negative electrode formed of a negative electrode current collector 2a and a lithium metal layer (negative electrode layer) 3a, or a negative electrode current collector 2b and a lithium metal layer (negative electrode layer) 3b; a positive electrode including a positive electrode current collector 4 and a positive electrode active material layer (positive electrode layer) 5a or 5b; and solid electrolyte layers 6a and 6b adjacent to the positive electrode active material layers (positive electrode layers) 5a or 5b.

The electrode stack 1 of the all-solid-state battery illustrated in FIGS. 1A and 1B further includes: an intermediate layer 7a arranged between the lithium metal layer (negative electrode layer) 3a and the solid electrolyte layer 6a; and an intermediate layer 7b arranged between the lithium metal layers (negative electrode layer) 3b and the solid electrolyte layer 6b. An insulating material 8a is arranged at both ends of the positive electrode active material layer (positive electrode layer) 5a, and an insulating material 8b is arranged at both ends of the positive electrode active material layer (positive electrode layer) 5b. In the drawings, Vd denotes a direction (plane direction) perpendicular to the stacking direction of the electrode stack 1 constituting the all-solid-state battery.

In the all-solid-state battery according to the first embodiment, the ends of the insulating materials 8a and 8b are arranged outward beyond the ends of the lithium metal layers (negative electrode layers) 3a and 3b and the ends of the negative electrode current collectors 2a and 2b, in the direction perpendicular to the stacking direction of the electrode stack 1.

In the all-solid-state battery according to the first embodiment, in the direction Vd perpendicular to the stacking direction of the electrode stack 1, a resin coating 9a is arranged at the ends of the electrode stack 1, in contact with the ends of the insulating materials 8a and 8b.

In the all-solid-state battery according to the first embodiment, the resin coating 9a is composed of two hard layers 11a and one soft layer 12a in the direction perpendicular to the stacking direction of the electrode stack 1. In the all-solid-state battery according to the first embodiment, the resin coating 9a is configured such that the hard layers 11a are arranged at both ends of the electrode stack 1 in the stacking direction, and the soft layer 12a is arranged approximately in the center of the resin coating 9a.

As illustrated in FIG. 1A, in the all-solid-state battery during full discharge (SOC: 0%), the lithium metal layers (negative electrode layers) 3a and 3b are in an unexpanded state, and the resin coating 9a provided at the end of the electrode stack 1 in the stacking direction extends to the same length as the thickness of the electrode stack 1, at the end of the electrode stack 1.

As illustrated in FIG. 1B, in the all-solid-state battery during full charge (SOC: 100%), the lithium metal layers (negative electrode layers) 3a and 3b expand, whereby the thickness (length in the stacking direction) of the electrode stack 1 becomes greater than the thickness of the electrode stack 1 during full discharge (SOC: 0%) as illustrated in FIG. 1A.

At this time, the resin coating 9a of the all-solid-state battery according to the first embodiment follows the expansion of the lithium metal layers (negative electrode layers) 3a and 3b, extending the length of the electrode stack 1 in the stacking direction. Specifically, the soft layer 12a arranged approximately in the center of the resin coating 9a stretches to follow the expansion of the lithium metal layers (negative electrode layers) 3a and 3b, thereby allowing the resin coating 9a of the all-solid-state battery according to the first embodiment to follow the increase in the thickness (length in the stacking direction) of the electrode stack 1 caused by the expansion of the lithium metal layers (negative electrode layers) 3a and 3b.

As a result, the all-solid-state battery according to the first embodiment prevents the positive electrode active material layers (positive electrode layers) and the solid electrolyte layers arranged at both ends of the electrode stack in the stacking direction from being pulled by the resin coating during the expansion of the lithium metal layers (negative electrode layers) during charging, thereby avoiding stress concentration in these regions.

In the resin coating 9a of the all-solid-state battery according to the first embodiment, at the end not in contact with the insulating materials 8a and 8b in the stacking direction of the electrode stack 1, the total length Ta of the hard layers 11a is greater than the length Tb of the soft layer 12a. The total length Ta of the hard layers 11a is greater than the length Tb of the soft layer 12a; therefore, stress during compressive input can be effectively alleviated, and deformation caused by bending during cell constraint or charging can be suppressed.

### Second Embodiment

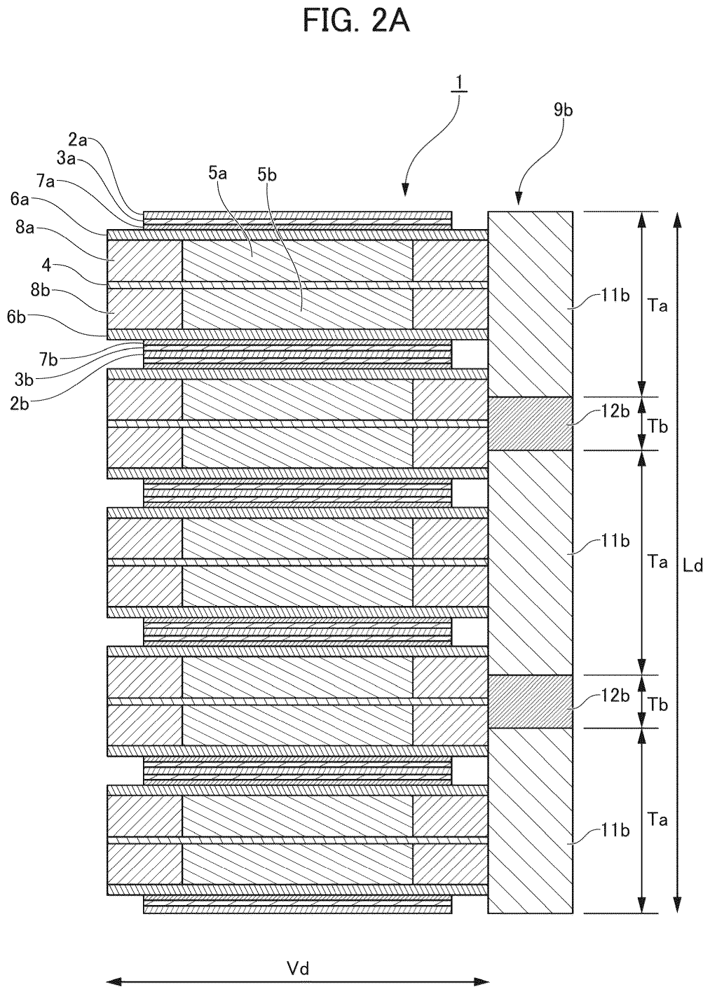

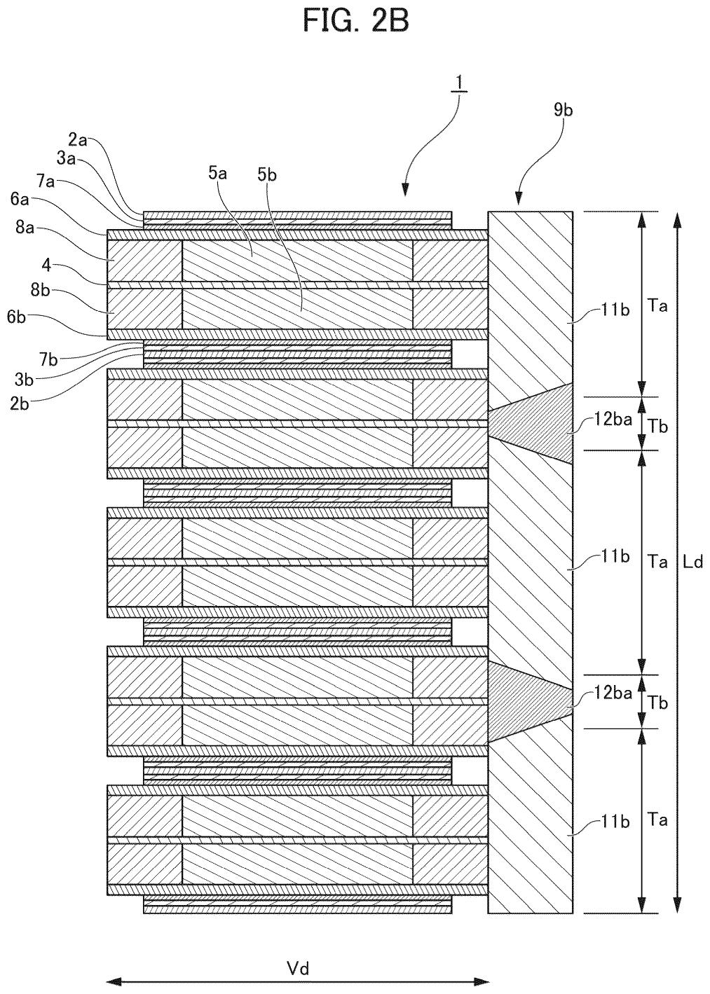

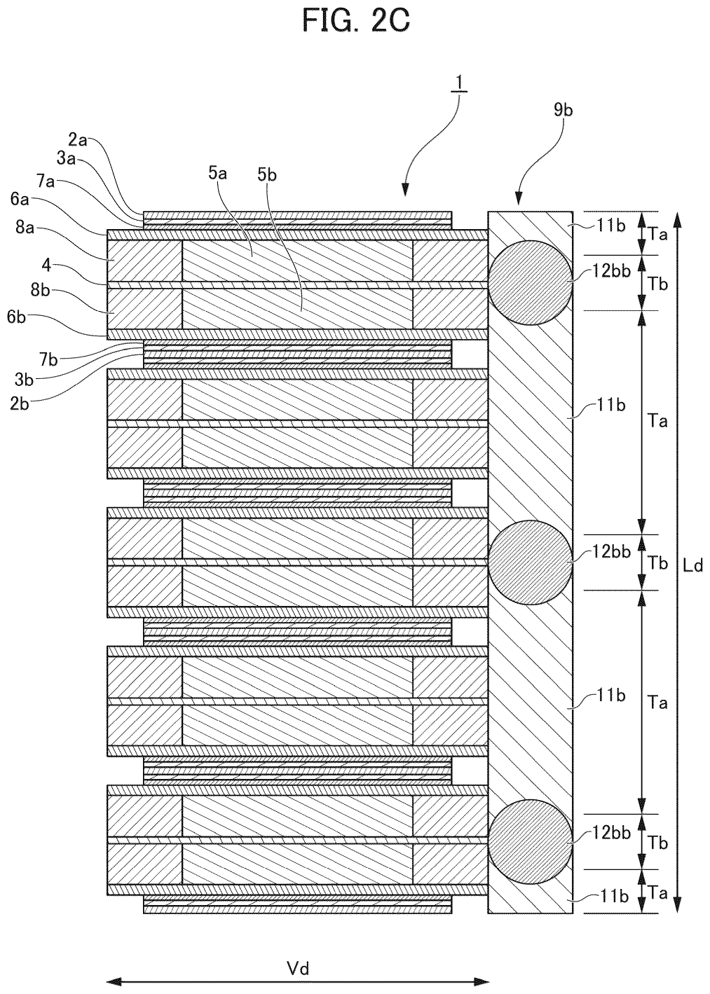

FIG. 2A is a cross-sectional view illustrating the configuration of an all-solid-state battery according to the second embodiment. The configuration of the electrode stack 1 in the all-solid-state battery according to the second embodiment is the same as that of the electrode stack 1 in the all-solid-state battery according to the first embodiment described above.

In the all-solid-state battery according to the second embodiment, as in the first embodiment, in a direction perpendicular to the stacking direction of the electrode stack 1, a resin coating 9b is arranged at the end of the electrode stack 1, in contact with the ends of the insulating materials 8a and 8b.

In the all-solid-state battery according to the second embodiment, the resin coating 9b is composed of three hard layers 11b and two soft layers 12b in the direction perpendicular to the stacking direction of the electrode stack 1. The resin coating 9b of the all-solid-state battery according to the second embodiment is configured such that the hard layers 11b are arranged at both ends of the electrode stack 1 in the stacking direction, and the soft layers 12b are interposed between the hard layers 11b.

The resin coating of the all-solid-state battery of the present disclosure preferably includes two or more soft layers. A resin coating including two or more soft layers can stretch at a plurality of points in response to the expansion of the lithium metal layers (negative electrode layers), thereby allowing for following the increase in thickness (length in the stacking direction) of the electrode stack caused by the expansion of the lithium metal layers (negative electrode layers) more uniformly. As a result, stress concentration at the ends of the electrode stack in the stacking direction can be further suppressed, accommodating the expansion and contraction of the negative electrode during charge and discharge cycles.

In the resin coating 9b of the all-solid-state battery according to the second embodiment, at the ends not in contact with the insulating materials 8a and 8b in the stacking direction of the electrode stack 1, the total length Ta of the hard layers 11b is greater than the total length Tb of the soft layers 12b.

The embodiment illustrated in FIG. 2A can include modifications as illustrated in FIGS. 2B and 2C. In FIGS. 2B and 2C, parts corresponding to those in FIG. 2A are denoted by the same reference numerals, and the descriptions are adopted from FIG. 2A.

In the modification illustrated in FIG. 2B, the two soft layers 12ba each have a trapezoidal cross-section, with the relative lengths of the upper and lower bases of the trapezoids being reversed sequentially in the stacking direction. The length Tb of the soft layers 12ba in FIG. 2B is dimensionally denoted as functionally equivalent to the length Tb of the soft layers 12b in FIG. 2A (length averaged in the Vd direction).

In the modification illustrated in FIG. 2C, the three soft layers 12bb have circular cross-sections of equal diameter. The length Tb of the soft layers 12bb in FIG. 2C is dimensionally denoted as functionally equivalent to the length Tb of the soft layers 12b in FIG. 2A when (length averaged in the Vd direction).

In the modifications illustrated in FIGS. 2B and 2C, as in the embodiment of FIG. 2A, the deformation of the soft layers 12ba or 12bb accommodates displacement in the Ld direction in response to the expansion and contraction of the negative electrode during charge and discharge cycles, thereby allowing for further suppressing stress concentration at the ends of the electrode stack in the stacking direction.

### Third Embodiment

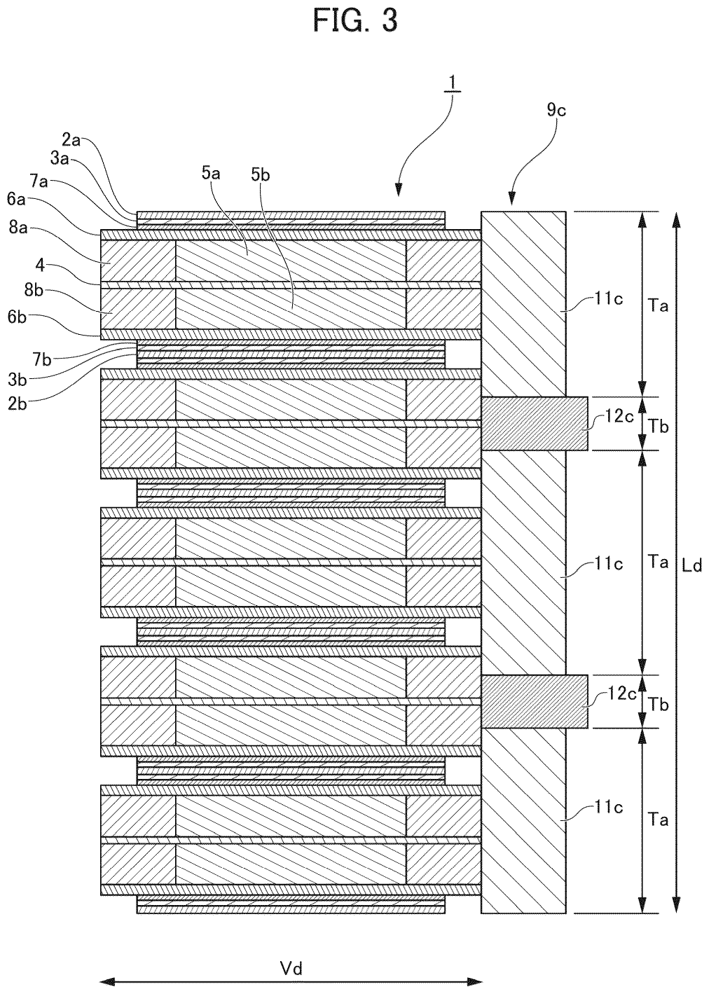

FIG. 3 is a cross-sectional view illustrating the configuration of an all-solid-state battery according to the third embodiment. The configuration of the electrode stack 1 in the all-solid-state battery according to the third embodiment is the same as that of the electrode stack 1 in the all-solid-state battery described according to the first embodiment described above.

In the all-solid-state battery according to the third embodiment, as in the first embodiment, in the direction perpendicular to the stacking direction of the electrode stack 1, a resin coating 9c is arranged at the end of the electrode stack 1, in contact with the ends of the insulating materials 8a and 8b.

In the all-solid-state battery according to the third embodiment, the resin coating 9c is composed of three hard layers 11c and two soft layers 12c in the direction perpendicular to the stacking direction of the electrode stack 1. In the all-solid-state battery according to the third embodiment, the resin coating 9c is configured such that the hard layers 11c are arranged at both ends of the electrode stack 1 in the stacking direction, and the soft layers 12c are interposed between the hard layers 11c.

In the resin coating 9c of the all-solid-state battery according to the third embodiment, in the direction Vd perpendicular to the stacking direction of the electrode stack 1, the ends of the two soft layers 12c extend outward beyond the ends of the three hard layers 11c. In other words, the width of the two soft layers 12c in the Vd direction is greater than that in the second embodiment described above. As a result, the proportion of the hard layers in the stacking direction can be ensured, allowing for increasing the deformation range of the soft layers to accommodate the expansion and contraction of the negative electrode during charge and discharge cycles.

In the resin coating of the all-solid-state battery of the present disclosure, the ends of the soft layers may extend outward beyond the ends of the hard layers in the direction perpendicular to the stacking direction of the electrode stack. Such a structure can be easily formed, for example, by first applying a resin for forming the soft layers to create the walls of the soft layers on the end face of the electrode stack, and then applying a resin for forming the hard layers between the walls of the soft layers.

In the resin coating 9c of the all-solid-state battery according to the third embodiment, at the ends not in contact with the insulating materials 8a and 8b in the stacking direction of the electrode stack 1, the total length Ta of the hard layers 11c is greater than the total length Tb of the soft layers 12c.

### Fourth Embodiment

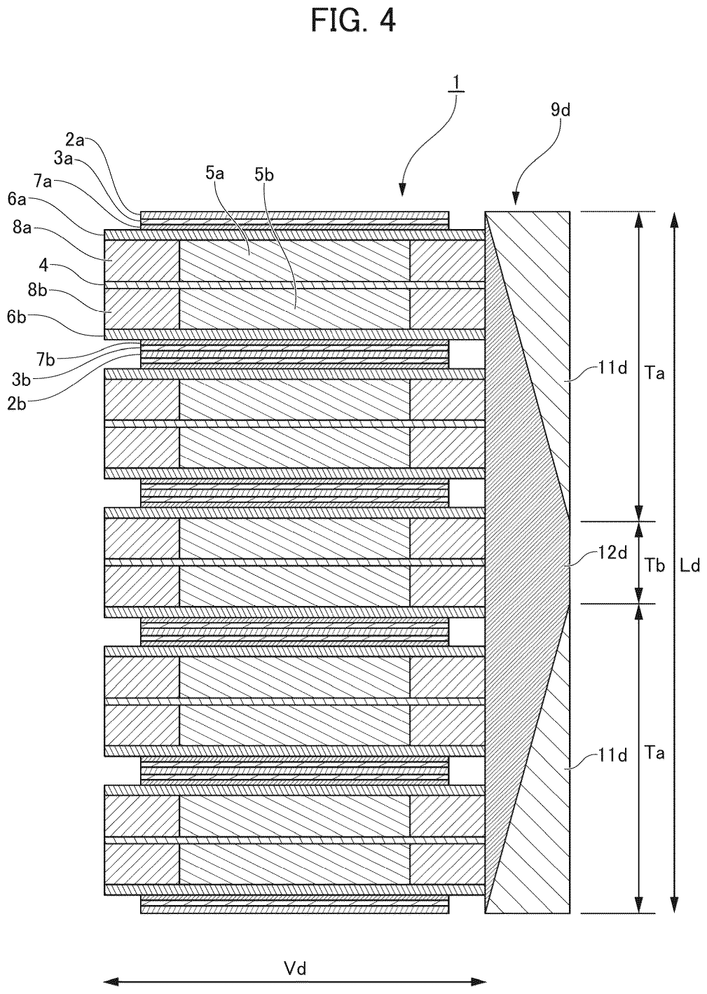

FIG. 4 is a cross-sectional view illustrating the configuration of an all-solid-state battery according to the fourth embodiment. The configuration of the electrode stack 1 in the all-solid-state battery according to the fourth embodiment is the same as that of the electrode stack 1 in the all-solid-state battery according to the first embodiment described above.

In the all-solid-state battery according to the fourth embodiment, as in the first embodiment, in the direction perpendicular to the stacking direction of the electrode stack 1, a resin coating 9d is arranged at the end of the electrode stack 1, in contact with the ends of the insulating materials 8a and 8b.

In the all-solid-state battery according to the fourth embodiment, the resin coating 9d includes two hard layers 11d and one soft layer 12d in the direction perpendicular to the stacking direction of the electrode stack 1. In the resin coating 9d of the all-solid-state battery according to the fourth embodiment, the soft layer 12d decreases in thickness from the end in contact with the insulating materials 8a and 8b toward the end not in contact with the insulating materials 8a and 8b in the direction perpendicular to the stacking direction of the electrode stack 1. In other words, the boundary between the hard layers 11d and the soft layer 12d is inclined relative to the Ld direction, as illustrated.

The resin coating of the all-solid-state battery of the present disclosure may include a soft layer that decreases in thickness from the end in contact with the insulating material toward the end not in contact with the insulating material, in the direction perpendicular to the stacking direction of the electrode stack. That is, as long as the hard layer and the soft layer are arranged in the direction perpendicular to the stacking direction of the electrode stack, the layers may not necessarily be parallel in the direction perpendicular to the stacking direction of the electrode stack.

The soft layer 12d in the resin coating 9d of the all-solid-state battery according to the fourth embodiment extends over a wide area, thereby allowing for following the expansion and contraction of the negative electrode during charge and discharge cycles, and further suppressing stress concentration at the ends of the electrode stack 1 in the stacking direction.

The hard layers 11d in the resin coating 9d of the all-solid-state battery according to the fourth embodiment are arranged at both ends of the electrode stack 1 in the stacking direction, and the total length Ta of the hard layers 11d at the ends not in contact with the insulating materials 8a and 8b in the stacking direction of the electrode stack 1 is greater than the length of the soft layer 12d, thereby allowing for effectively alleviating stress during compressive input, and suppressing deformation caused by bending during cell constraint or charging.

### (Configuration of All-Solid-State Battery)

The configurations of the all-solid-state battery of the present disclosure will be described below.

### (Positive Electrode Current Collector)

The positive electrode current collector used in the all-solid-state battery of the present disclosure is arranged in contact with the positive electrode layer, and functions to collect current from the positive electrode layer. The material for the positive electrode current collector is not particularly limited, as long as the material can collect current from the positive electrode layer. Examples of materials for the positive electrode current collector include aluminum, aluminum alloys, stainless steel, nickel, iron, and titanium. Among these, at least one selected from the group consisting of aluminum, aluminum alloys, and stainless steel is preferred.

The shape of the positive electrode current collector is not particularly limited, and may include, for example, foil or plate forms. The thickness of the positive electrode current collector is not particularly limited, and may be the same as those used in positive electrodes of typical all-solid-state batteries. The thickness of the positive electrode current collector may range, for example, between 0.5 μm and 0.5 mm inclusive.

### (Positive Electrode Layer)

The positive electrode layer is a layer containing at least a positive electrode active material. The positive electrode active material contained in the positive electrode layer is not particularly limited, as long as the material is the one typically used in positive electrode layers of all-solid-state batteries. Examples of positive electrode active materials for lithium-ion batteries include lithium-containing layered active materials, spinel-type active materials, and olivine-type active materials. Specific examples of positive electrode active materials include lithium cobalt oxide (LiCoO₂), lithium nickel oxide (LiNiO₂), LiNiₚMn_{g}CoᵣO₂ (p+q+r=1), LiNiₚAl_{q}CoᵣO₂ (p+q+r=1), lithium manganese oxide (LiMn₂O₄), Li₁₊ₓMn_{2-x-y}M_{y}O₄ (x+y=2, M=at least one selected from Al, Mg, Co, Fe, Ni, or Zn), lithium titanium oxide (oxide containing Li and Ti), and lithium metal phosphate (LiMPO₄, M=at least one selected from Fe, Mn, Co, or Ni).

The content of the positive electrode active material in the positive electrode layer may range between 50% by mass and 99% by mass inclusive, for example. The positive electrode active material may have a surface coated with an oxide layer such as a lithium niobate layer, a lithium titanate layer, or a lithium phosphate layer.

The positive electrode layer may optionally include a solid electrolyte, described later, to improve lithium-ion conductivity. The positive electrode layer may also optionally contain binders or conductive additives. These materials may be those typically used for all-solid-state batteries.

The thickness of the positive electrode layer is not particularly limited, and can be appropriately set based on the desired battery performance. For example, the thickness of the positive electrode layer may range between 1 μm and 1 mm inclusive.

In a case where the all-solid-state battery of the present disclosure includes an intermediate layer described later, the area of the positive electrode layer is preferably equivalent to the area of the intermediate layer on the stacking surface. As a result, the durability performance of the all-solid-state battery can be improved. The area of the positive electrode layer in the all-solid-state battery of the present disclosure may be up to 100%, 90%-100%, or 80%-90% of the area of the intermediate layer.

The method of manufacturing the positive electrode layer is not particularly limited, and the positive electrode layer may be manufactured with publicly known methods. For example, the positive electrode layer can be manufactured by mixing the materials constituting the positive electrode layer with a solvent to form a slurry, applying the slurry to the positive electrode current collector described above, followed by drying.

### (Solid Electrolyte Layer)

The solid electrolyte layer is a layer containing a solid electrolyte. The solid electrolyte layer is arranged in contact with the positive electrode layer and the insulating material.

The material for the solid electrolyte is not particularly limited, as long as the material has lithium-ion conductivity and insulation properties. Materials typically used in all-solid-state lithium-ion batteries can be used as the solid electrolyte. Examples include inorganic solid electrolytes such as sulfide solid electrolytes, oxide solid electrolytes, halide solid electrolytes, and lithium-containing salts; polymer-based solid electrolytes such as polyethylene oxide; and gel-based solid electrolytes containing lithium salts or lithium-ion conductive ionic liquids. Among these, sulfide solid electrolytes are preferred for the high lithium-ion conductivity and favorable characteristics for press forming and interface bonding.

The form of the solid electrolyte material is not particularly limited, and may be, for example, particulate. In the solid electrolyte layer in the all-solid-state battery of the present disclosure, the content of the solid electrolyte is not particularly limited. For example, the content of the solid electrolyte may range between 50% by mass and 99% by mass inclusive.

The solid electrolyte layer may optionally contain a binder. The solid electrolyte layer may also optionally include an adhesive to impart mechanical strength or flexibility. These materials may be those typically used in all-solid-state batteries.

The solid electrolyte layer may be arranged such that the end substantially aligns with the end of the insulating material in the direction perpendicular to the stacking direction of the electrode stack in the all-solid-state battery of the present disclosure.

In the electrode stack with such a shape, the solid electrolyte layer does not protrude from the end face of the electrode stack, thereby allowing for reducing the risk of cracks forming in the solid electrolyte layer, in a case where pressure, such as from roll pressing, is applied during the manufacturing process of the electrode stack.

The method of manufacturing the solid electrolyte layer is not particularly limited, and the solid electrolyte layer may be manufactured with publicly known methods. For example, the solid electrolyte layer can be manufactured by mixing the materials constituting the solid electrolyte layer with a solvent to form a slurry, applying the slurry to a substrate, followed by drying.

### (Negative Electrode Current Collector)

The negative electrode current collector used in the all-solid-state battery of the present disclosure is arranged in contact with the negative electrode layer, and functions to collect current from the negative electrode layer. The material for the negative electrode current collector is not particularly limited, as long as the material can collect current from the negative electrode layer. However, the material preferably has high electrical conductivity. Examples of materials with high electrical conductivity include metals containing at least one metallic element selected from the group consisting of silver, palladium, gold, platinum, aluminum, copper, and nickel; alloys such as stainless steel; or non-metals such as carbon (C).

Among these materials with high electrical conductivity, at least one material selected from the group consisting of copper, SUS (stainless steel), and nickel is preferably used considering both electrical conductivity and manufacturing cost. In particular, stainless steel is less reactive with the negative electrode active material, the positive electrode active material, and the solid electrolyte. Therefore, using stainless steel as the material for the negative electrode current collector can reduce the internal resistance of the all-solid-state battery.

The shape of the negative electrode current collector is not particularly limited, and may include forms such as foil, plate, mesh, nonwoven fabric, or foam. The negative electrode current collector may have a surface coated with a carbon layer, or have a surface roughened, in order to enhance adhesion with the negative electrode layer.

The thickness of the negative electrode current collector is not particularly limited, and may be the same as those used in negative electrodes of typical all-solid-state batteries. The thickness of the negative electrode current collector may range, for example, between 0.5 μm and 0.5 mm inclusive.

### (Negative Electrode Layer)

The negative electrode layer is a layer containing a negative electrode active material that exchanges lithium ions and electrons. The negative electrode active material contained in the negative electrode layer is not particularly limited, as long as the material is the one typically used in negative electrode layers of all-solid-state batteries. However, a material with high electronic conductivity is preferably used to enable reversible lithium-ion release/storage and to facilitate electron transport. Examples of such negative electrode active materials include silicon-based active materials such as silicon and silicon alloys; carbon-based active materials such as graphite and hard carbon; oxide-based active materials such as lithium titanium oxide; lithium-based active materials such as lithium metal and lithium alloys. The negative electrode active material may be used alone or in combination of two or more types.

In the all-solid-state battery of the present disclosure, the negative electrode layer may consist of lithium metal or a lithium metal alloy, alone or in combination. A negative electrode layer including lithium metal or lithium metal alloy, alone or in combination, has high electrical capacitance per unit weight, thus can realize a high-capacity all-solid-state battery.

The content of the negative electrode active material in the negative electrode layer may range, for example, between 30% by mass and 100% by mass inclusive.

The negative electrode layer may optionally contain the solid electrolyte described above to improve lithium-ion conductivity. The negative electrode layer may also optionally contain binders or conductive additives. These materials may be those typically used for all-solid-state batteries.

The thickness of the negative electrode layer is not particularly limited, and can be appropriately set based on the desired battery performance. The thickness of the negative electrode layer may range, for example, between 0.5 μm and 0.5 mm inclusive.

The method of manufacturing the negative electrode layer is not particularly limited, and the negative electrode layer may be manufactured with publicly known methods. For example, the negative electrode layer can be manufactured by mixing the materials constituting the negative electrode layer with a solvent to form a slurry, applying the slurry to the negative electrode current collector mentioned above, followed by drying.

### (Intermediate Layer)

In a case where the all-solid-state battery of the present disclosure includes an intermediate layer, the intermediate layer is provided between the solid electrolyte and the negative electrode layer. In a case where the negative electrode layer of the all-solid-state battery of the present disclosure consists of lithium metal or a lithium metal alloy, alone or in combination, the intermediate layer provided between the solid electrolyte layer and the negative electrode layer can suppress uneven dendritic deposition at the interface between the solid electrolyte layer and the negative electrode layer and improve interfacial adhesion.

The intermediate layer is a layer having both electronic conductivity and ionic conductivity. The intermediate layer has ionic conductivity, thus can allow lithium ions to pass through. Therefore, during repeated charge and discharge cycles of the all-solid-state battery, lithium ions (Lit) migrating from the solid electrolyte layer to the negative electrode layer pass through the intermediate layer. The presence of the intermediate layer allows uniform deposition of lithium metal between the intermediate layer and the negative electrode layer. In a case where the intermediate layer has flexibility to follow the changes in volume of each layer during charge and discharge cycles, interfacial adhesion can be maintained even after repeated charge and discharge cycles of the all-solid-state battery, thereby allowing for improving the durability of the all-solid-state battery.

The intermediate layer may be arranged such that the end substantially aligns with the end of the negative electrode layer, or may be arranged inside the end of the negative electrode layer, in the direction perpendicular to the stacking direction of the electrode stack in the all-solid-state battery of the present disclosure. As a result, the effects by providing the intermediate layer as described above can be sufficiently achieved.

The material constituting the intermediate layer is not particularly limited. For example, the intermediate layer may contain amorphous carbon, metal nanoparticles, and binders as binding agents.

Amorphous carbon, unlike graphite and similar materials, does not react with lithium metal to form an alloy. This characteristic suppresses dendritic formation, thereby allowing for improving the cycle characteristics of the all-solid-state battery.

Examples of amorphous carbon include carbon blacks such as acetylene black, furnace black, and Ketjen black, as well as coke and activated carbon. Amorphous carbon may also include graphitizable carbon (soft carbon), non-graphitize carbon (hard carbon), CNT (carbon nanotubes), fullerenes, and graphene.

Metal nanoparticles included in the intermediate layer can enhance the electronic conductivity of the intermediate layer, allowing for more uniform deposition of lithium metal. Examples of metal nanoparticles are not particularly limited, and include tin, silicon, zinc, magnesium, gold, platinum, palladium, silver, aluminum, bismuth, and antimony nanoparticles.

The binder included in the intermediate layer maintains the structure of the intermediate layer, and improves adhesion between the particles constituting the intermediate layer, and between the intermediate layer and the solid electrolyte layer. The binder is not particularly limited, and may be a material typically used in all-solid-state batteries.

### (Insulating Material)

The insulating material is provided on the surface of the positive electrode current collector on the side of the positive electrode layer, adjacent to the end of the positive electrode layer. The insulating material is arranged at the ends of the positive electrode layer, thereby allowing for preventing short-circuits during battery operation when tab wires extending from the negative electrode current collectors of individual cell structures are bent, avoiding contact between the tab wires and the ends of the positive electrode. This configuration can also suppress short-circuits caused by cracks generated during repeated charge and discharge cycles. Furthermore, cracks can be prevented from forming at the ends of the positive electrode mixture layer due to roll-over during roll pressing of the positive electrode.

The shape of the insulating material is not particularly limited as long as the insulating material is provided at the ends of the positive electrode layer. The size of the insulating material is also not particularly limited, as long as the insulating material has a thickness equal to or less than the thickness of the positive electrode layer in the stacking direction of the electrode stack, and is arranged at the ends of the positive electrode layer in the direction perpendicular to the stacking direction of the electrode stack, in contact with part or all of the ends of the positive electrode layer.

The material for the insulating material is not particularly limited, and may be any insulator other than semiconductors and conductors, as long as the material exhibits insulating properties. The material for the insulating material can be appropriately selected based on the properties desired in addition to insulating properties.

The method of manufacturing the insulating material is not particularly limited. For example, the insulating material can be manufactured by applying a slurry containing an insulating material onto the positive electrode current collector, on which the positive electrode layer has been formed, followed by drying.

### (Resin Coating)

The resin coating of the all-solid-state battery of the present disclosure is provided at the end of the electrode stack in the stacking direction of the electrode stack, in contact with the end of the insulating material, and is composed of a hard layer and a soft layer in the direction perpendicular to the stacking direction of the electrode stack. The resin coating of the all-solid-state battery of the present disclosure only needs to be provided in contact with the end of the insulating material, and may or may not extend into the space adjacent to the ends of the negative electrode layer and the negative electrode current collector, which are arranged inside the end of the insulating material in the direction perpendicular to the stacking direction of the electrode stack.

The method of manufacturing a resin coating including these two types of layers is not particularly limited. For example, a resin forming the soft layer may be applied in a strip to produce walls, and then a resin forming the hard layer may be applied between the walls. Another method involves using UV-curable resin, masking the UV exposure area, and differentiating the degree of curing by varying the UV exposure intensity and duration to form the hard layer and the soft layer.

The material for the resin coating is not particularly limited, as long as the material can produce both the hard layer and the soft layer. A resin with a high Young's modulus may be used to form the hard layer, while a resin with a low Young's modulus may be used to form the soft layer. Alternatively, a single type of UV-curable resin may be used, adjusting the curing degree through UV exposure intensity and duration to form the hard layer and the soft layer. The thickness of the resin coating (average thickness considering misalignment or uneven application in each electrode group) may range, for example, between 0.05 mm and 20 mm inclusive.

Examples of materials for the hard layer include resins. Resins include rubber and elastomer. Examples of resins include PE, PP, PTFE, PVdF, and SBR. These resins may be used alone or in combination of two or more. Materials for the soft layer may include those with lower Young's modulus among the aforementioned materials for the hard layer. Examples of UV-curable resins adjustable via UV exposure include acrylic resin and epoxy resin.

### (Method of Manufacturing All-Solid-State Battery)

The method of manufacturing the all-solid-state battery of the present disclosure is not particularly limited, and may employ publicly known methods. For example, the negative electrode current collector, the negative electrode layer, the intermediate layer, the solid electrolyte layer, the positive electrode layer, and the positive electrode current collector are stacked in this order, and the insulating material is formed on the positive electrode current collector at both ends of the positive electrode layer, thereby producing an electrode body. Subsequently, a plurality of electrode bodies are stacked, optionally pressed for integration, thereby forming an electrode stack. Finally, a resin coating is formed at the end of the electrode stack, thereby allowing for producing the all-solid-state battery of the present disclosure.

The preferred embodiments of the present invention have been described above; however, the present invention is not limited to the embodiments described above, and modifications or improvements within the scope of achieving the object of the present invention are included in the present invention.

### EXPLANATION OF REFERENCE NUMERALS

1: electrode stack
2a, 2b: negative electrode current collector
3a, 3b: lithium metal layer (negative electrode layer)
4: positive electrode current collector
5a, 5b: positive electrode active material layer (positive electrode layer)
6a, 6b: solid electrolyte layer
7a, 7b: intermediate layer
8a, 8b: insulating material
9: resin coating
11a, 11b, 11c: hard layer
12a, 12b, 12c: soft layer
Ld: stacking direction of electrode stack
Vd: direction (plane direction) perpendicular to stacking direction of electrode stack
Ta: thickness of hard layer at end of resin coating
Tb: thickness of soft layer at end of resin coating

What is claimed is:

1. An all-solid-state battery, comprising:
an electrode stack including a plurality of electrode bodies stacked, each of the electrode bodies including a positive electrode current collector, a positive electrode layer, a solid electrolyte layer, a negative electrode layer, and a negative electrode current collector stacked in this order, wherein
the positive electrode current collector includes an insulating material on a surface on a side of the positive electrode layer, adjacent to an end of the positive electrode layer,
the solid electrolyte layer is arranged in contact with the positive electrode layer and the insulating material,
an end of the insulating material is arranged outward beyond an end of the negative electrode layer and the negative electrode current collector, in a direction perpendicular to a stacking direction of the electrode stack,
a resin coating is arranged at an end of the electrode stack, in contact with the end of the insulating material, in the stacking direction of the electrode stack,
the resin coating includes a hard layer and a soft layer in the direction perpendicular to the stacking direction of the electrode stack, and
the hard layer is arranged at both ends of the electrode stack in the stacking direction.

2. The all-solid-state battery according to claim 1, wherein the hard layer is longer than the soft layer, at an end of the resin coating not in contact with the insulating material, in the stacking direction of the electrode stack.

3. The all-solid-state battery according to claim 1, wherein the soft layer includes two or more layers.

4. The all-solid-state battery according to claim 1, wherein an end of the soft layer extends outward beyond an end of the hard layer, in the direction perpendicular to the stacking direction of the electrode stack.

5. The all-solid-state battery according to claim 1, wherein a thickness of the soft layer decreases from an end in contact with the insulating material toward an end not in contact with the insulating material, in the direction perpendicular to the stacking direction of the electrode stack.
